(19) United States
(12) Patent Application Publication
(10) Pub. No.: US 2012/0066532 A1
(43) Pub. Date: Mar. 15, 2012

(54) ELECTRONIC DEVICE AND METHOD FOR SAVING ENERGY THEREOF

(75) Inventors: SHIH-FANG WONG, Tu-Cheng (TW); XIN LU, Shenzhen (CN); XUE-SHUN LIU, Shenzhen City (CN); JUN-JIE LI, Shenzhen City (CN); BIAO-GENG ZHONG, Shenzhen City (CN); HUAN-HUAN ZHANG, Shenzhen City (CN); DAN WANG, Shenzhen City (CN); BI-QING LUO, Shenzhen City (CN); FEI WANG, Shenzhen (CN); LI-XIA PENG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/048,871

(22) Filed: Mar. 16, 2011

(30) Foreign Application Priority Data
Sep. 13, 2010 (CN) 201010279657.8

(51) Int. Cl. G06F 1/32

(52) U.S. Cl. 713/323

(57) ABSTRACT

An electronic device includes a dynamic memory, a static memory, a detection unit, a copy unit and a set unit. The dynamic memory stores an interrupt monitoring program. The interrupt monitoring program monitors whether an interrupt request is generated, and generates an interrupt signal when the interrupt request is generated. The detection unit detects whether the electronic device needs to enter a sleep mode, and generates a detection signal if the electronic device needs to enter the sleep mode. The copy unit copies the interrupt monitoring program from the dynamic memory to the static memory in response to the detection signal, and runs the interrupt monitoring program in the static memory for monitoring whether an interrupt signal is generated. The set unit sets the dynamic memory into a self-refresh mode in response to the detection signal.

### BACKGROUND

1. Technical Field

The present disclosure relates to electronic devices, and more particularly to a method for saving energy used by the electronic devices.

2. Description of Related Art

A typical electronic device often enters a sleep mode, for energy saving, such that CPU clock frequency is decreased, and peripheral devices connected to the CPU are disabled, when the typical electronic device is not being used. At the same time, for the sake of interrupt requests capable of being monitored by the typical electronic device in the sleep mode, an interrupt monitoring program is stored in a dynamic memory connected to the CPU, and the dynamic memory remains in an auto-refresh mode. However, the dynamic memory in the auto-refresh mode still consumes a great deal of energy.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with an exemplary embodiment.

FIG. 2 is a flowchart of a method for saving energy in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

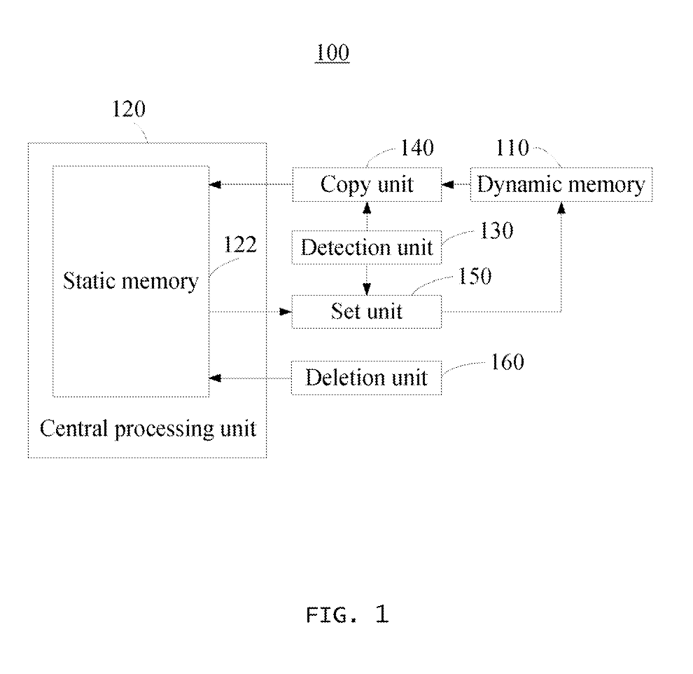

Referring to FIG. 1, an electronic device 100 includes a dynamic memory 110, a central processing unit (hereinafter “CPU”) 120, a detection unit 130, a copy unit 140, a set unit 150 and a deletion unit 160. The electronic device 100 includes a normal mode and a sleep mode, and is capable of switching between the normal mode and the sleep mode according to user's requirements. A default mode of the electronic device 100 is the normal mode.

The dynamic memory 110 includes an auto-refresh mode and a self-refresh mode, and is capable of switching between the auto-refresh mode and the self-refresh mode. Energy consumed by the dynamic memory 110 in the auto-refresh mode is greater than that in the self-refresh mode. The dynamic memory 110 is used for storing an interrupt monitoring program. The interrupt monitoring program is used for monitoring whether an interrupt request is generated, and generating an interrupt signal when the interrupt request is generated. A default mode of the dynamic memory 110 is the auto-refresh mode. The dynamic memory 110 may be a SDRAM.

The CPU 120 often integrates a static memory 122 thereinto. The static memory 122 can be used as a buffer memory when the CPU performs a task. The static memory 122 may be a SRAM.

The detection unit 130 is used for detecting whether the electronic device 100 is needed to enter the sleep mode; and generating a detection signal when it is determined that the electronic device 100 is needed to enter the sleep mode. In the embodiment, the detection unit 130 is a key arranged on the electronic device 100, and when the key is pressed, the detection signal is generated.

The copy unit 140 is used for copying the interrupt monitoring program from the dynamic memory 110 to the static memory 122 in response to the detection signal, and running the interrupt monitoring program in the static memory 122 for monitoring whether an interrupt request is generated.

The set unit 150 is adapted to set the dynamic memory 110 in the self-refresh mode in response to the detection signal, and backup current system parameters of the dynamic memory 110 and the electronic device 100, thus the electronic device 100 enters the sleep mode. Because the energy consumed by the dynamic memory 110 in the auto-refresh mode is greater than that in the self-refresh mode, the electronic device 100 can use less energy than the typical electronic device.

The set unit 150 is further used for responding to the interrupt signal to set the dynamic memory 110 into the auto-refresh mode, and recover the backup system parameters of the dynamic memory 110 and the electronic device 100 such that the electronic device 100 enters the normal mode responding to the interrupt request.

The deletion unit 160 is used for responding to the interrupt signal to delete the interrupt monitoring program from the static memory 122, such that a running speed of the CPU 120 is not decreased because of the interrupt monitoring program stored in the static memory 122.

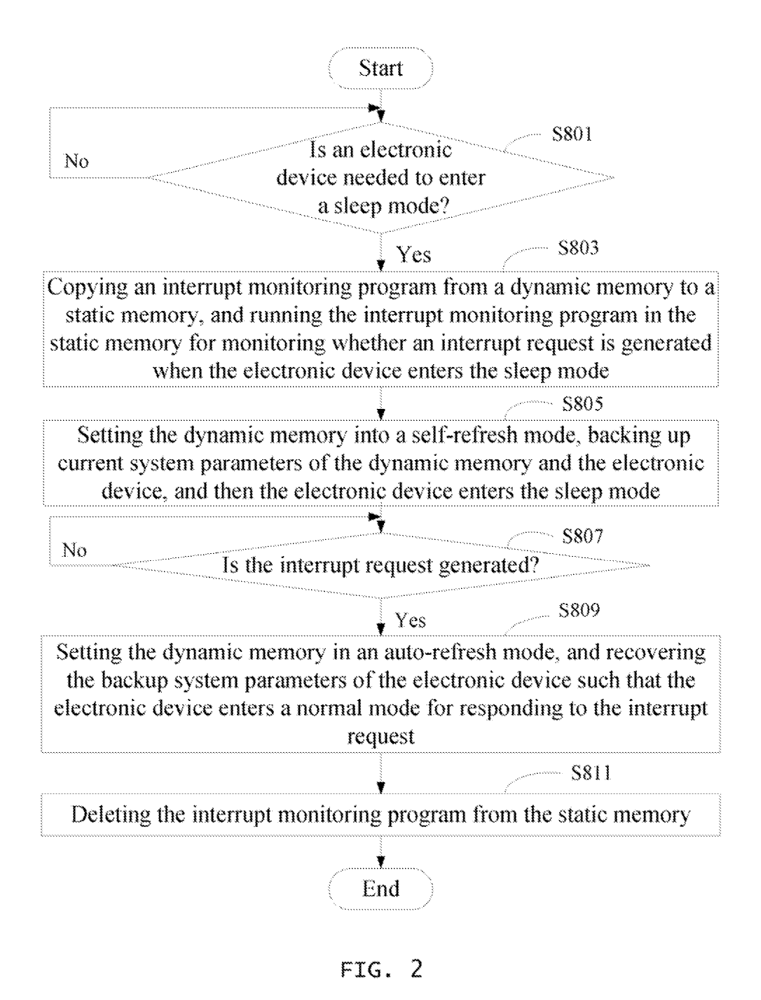

Referring to FIG. 2, a method for saving energy used in an electronic device is provided. The electronic device includes a sleep mode and a normal mode, and is capable of switching between the normal mode and the sleep mode according to user's input. A default mode of the electronic device is the normal mode. The electronic device includes a dynamic memory and a central processing unit (CPU). The dynamic memory includes an auto-refresh mode and a self-refresh mode, and is capable of switching between the auto-refresh mode and the self-refresh mode. Energy consumed by the dynamic memory in the auto-refresh mode is greater than that in the self-refresh mode. The dynamic memory is used for storing an interrupt monitoring program. The interrupt monitoring program is used for monitoring whether an interrupt request is generated. A default mode of the dynamic memory is the auto-refresh mode. The dynamic memory may be a SDRAM. The CPU often integrates a static memory thereinto. The static memory can be used as a buffer memory when the CPU performs a task. The static memory may be a SRAM. The method includes the following steps.

In step S801, it is detected whether an electronic device is needed to enter the sleep mode. If the electronic device is needed to enter the sleep mode, step S803 is implemented. If the electronic device is not needed to enter the sleep mode, step S801 is repeated. In the embodiment, the electronic device 100 arranges a key thereon, and when the key is pressed, the electronic device enters the sleep mode.

In step S803, the interrupt monitoring program is copied from the dynamic memory to the static memory, and the interrupt monitoring program in the static memory is run to monitor whether an interrupt request is generated when the electronic device enters the sleep mode.

In step S805, the dynamic memory is set in the self-refresh mode, current system parameters of the dynamic memory and the electronic device are backed up, and then the electronic device enters the sleep mode. Because the energy consumed by the dynamic memory in the auto-refresh mode is greater than in the self-refresh mode, the electronic device using the above method can save more energy than the typical electronic device.

In step S807, it is determined whether an interrupt request is generated. If it is determined that the interrupt request is generated, step S809 is implemented. If it is determined that the interrupt request is not generated, step S807 is repeated.

In step S809, the dynamic memory is set in the auto-refresh mode, and the backup system parameters of the dynamic memory and the electronic device is recovered such that the electronic device enters the normal mode for responding to the interrupt request.

In step S811, the interrupt monitoring program is deleted from the static memory, such that a running speed of the CPU is not decreased because of the interrupt monitoring program stored in the static memory.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device, comprising a normal mode and a sleep mode, and being capable of switching between the normal mode and the sleep mode, the electronic device further comprising:
a dynamic memory comprising an auto-refresh mode and a self-refresh mode, and being capable of switching between the auto-refresh mode and the self-refresh mode; energy consumed by the dynamic memory in the auto-refresh mode being greater than that in the self-refresh mode; the dynamic memory being adapted to store an interrupt monitoring program which is used for monitoring whether an interrupt request is generated, and generating an interrupt signal when the interrupt request is generated;
a central processing unit integrating a static memory thereinto;
a detection unit adapted to detect whether the electronic device is needed to enter the sleep mode; and generating a detection signal when it is determined that the electronic device is needed to enter the sleep mode;
a copy unit adapted to copy the interrupt monitoring program from the dynamic memory to the static memory in response to the detection signal, and run the interrupt monitoring program in the static memory for monitoring whether an interrupt request is generated; and
a set unit adapted to set the dynamic memory in the self-refresh mode in response to the detection signal, and backup current system parameters of the dynamic memory and the electronic device, thus the electronic device enters the sleep mode.

2. The electronic device according to claim 1, wherein the set unit is further adapted to respond to the interrupt signal to set the dynamic memory into the auto-refresh mode, and recover the backup system parameters of the dynamic memory and the electronic device such that the electronic device enters the normal mode for responding to the interrupt request.

3. The electronic device according to claim 2, further comprising a deleting unit for responding to the interrupt signal to delete the interrupt monitoring program from the static memory.

4. A method for saving energy, used in an electronic device; the electronic device comprising a sleep mode and a normal mode, and being capable of switching between the normal mode and the sleep mode; the electronic device comprising a dynamic memory and a central processing unit with a static memory; the dynamic memory comprising an auto-refresh mode and a self-refresh mode, and being capable of switching between the auto-refresh mode and the self-refresh mode; energy used by the dynamic memory in the auto-refresh mode being greater than that in the self-refresh mode; the dynamic memory adapted to store an interrupt monitoring program for monitoring whether an interrupt request is generated; the method comprising:
detecting whether the electronic device is needed to enter the sleep mode;
if the electronic device is needed to enter the sleep mode, copying the interrupt monitoring program from the dynamic memory to the static memory, and running the interrupt monitoring program in the static memory to monitor whether an interrupt request is generated when the electronic device enters the sleep mode; and
setting the dynamic memory in the self-refresh mode, and backing up current system parameters of the dynamic memory and the electronic device in order that the electronic device enters the sleep mode.

5. The method according to claim 4, further comprising:
if the electronic device is not needed to enter the sleep mode, step of detecting whether the electronic device is needed to enter the sleep mode is further implemented.

6. The method according to claim 4, further comprising:
determining whether an interrupt request is generated;
if it is determined that the interrupt request is generated, setting the dynamic memory in the auto-refresh mode, and recovering the backup system parameters of the dynamic memory and the electronic device such that the electronic device enters the normal mode for responding to the interrupt request.

7. The method according to claim 6, further comprising:
if it is determined that the interrupt request is not generated, step of determining whether an interrupt request is generated is implemented.

8. The method according to claim 6, further comprising:
deleting the interrupt monitoring program from the static memory after step of setting the dynamic memory in the auto-refresh mode, and recovering the backup system parameters of the dynamic memory and the electronic device such that the electronic device enters the normal mode for responding to the interrupt request.

9. An electronic device with a normal mode and a sleep mode, the electronic device comprising:
a dynamic memory comprising an auto-refresh mode and a self-refresh mode; energy wasted by the dynamic memory in the auto-refresh mode being more than that in the self-refresh mode; the dynamic memory adapted to store an interrupt monitoring program for monitoring whether an interrupt request is generated;
a static memory;
a copy unit adapted to copy the interrupt monitoring program from the dynamic memory to the static memory, and run the interrupt monitoring program in the static memory for monitoring whether an interrupt request is generated when the electronic device is need to enter the sleep mode; and
a set unit adapted to set the dynamic memory in the self-refresh mode and backup current system parameters of the dynamic memory and the electronic device when the electronic device is needed to enter the sleep mode.

10. The electronic device according to claim 9, wherein the set unit is further adapted to set the dynamic memory into the auto-refresh mode, and recover the backup system parameters of the dynamic memory and the electronic device such that the electronic device enters the normal mode for responding to the interrupt request when the interrupt request is generated.

11. The electronic device according to claim 10, further comprising a deleting unit adapted to delete the interrupt monitoring program from the static memory when the interrupt request is generated.

12. The electronic device according to claim 9, further comprising a central processing unit, and the static memory being integrated into the central processing unit.

13. The electronic device according to claim 9, further comprising a detection unit adapted to detect whether the electronic device is needed to enter the sleep mode.
